(19) United States
(12) Patent Application Publication
(10) Pub. No.: US 2026/0034496 A1
(43) Pub. Date: Feb. 5, 2026

(54) PROCESS FOR STARTING UP A CARBON CAPTURE PROCESS

(71) Applicant: L'Air Liquide, Societe Anonyme pour Etude et L'Exploitation des Procedes Georges Claude, Paris (FR)

(72) Inventors: Laura RICCI, Champigny-Sur-Marne (FR); Abigail BONIFACIO, Houston, TX (US); Mathieu LECLERC, Champigny-Sur-Marne (FR); Michele MURINO, Champigny-Sur-Marne (FR); Jean-Baptiste CHAIX, Champigny-Sur-Marne (FR)

(73) Assignee: L'Air Liquide, Societe Anonyme pour Etude et L'Exploitation des Procedes Georges Claude, Paris (FR)

(21) Appl. No.: 18/792,958

(22) Filed: Aug. 2, 2024

(51) Int. Cl. B01D 53/00; B01D 3/14

(52) U.S. Cl. CPC B01D 53/002; B01D 3/14; F25J 3/0266; F25J 3/067; B01D 2257/504; B01D 2258/0283

(57) ABSTRACT

The carbon capture process includes, under normal operation: a first stream is compressed, dried, cooled and separated by partial condensation step a phase separator forming a liquid enriched in CO2 and a gas enriched in the at least one component lighter than CO2. And the gas enriched in the component lighter than CO2 is warmed in the heat exchanger and then expanded in a turbine, and then is sent to the atmosphere or to a cooling tower. Under start-up conditions, a phase separator is at a first temperature and a second stream of a gaseous mixture containing CO2 and at least one component lighter than CO2 is expanded in the turbine to produce an expanded gas at a second temperature different from the first temperature, the expanded gas being then warmed in the heat exchanger or sent to be separated in a distillation column of the carbon capture process.

### BACKGROUND

The present invention relates to a process for starting up a carbon capture process. In a carbon capture process performed at low temperature, under normal operation, a gaseous mixture is separated by partial condensation and possibly distillation and/or solidification, the gaseous mixture comprising CO2 and at least one component lighter than CO2 and preferably at least one component heavier than CO2. The mixture is compressed, dried, purified if impurities that could freeze are present, cooled and separated by partial condensation in at least one phase separator. The CO2 in the phase separator is mostly in the liquid phase and the gas phase is enriched in the at least one lighter component as compared with the mixture. The gas from the phase separator is expanded and emitted to the atmosphere with or without pretreatment.

This expansion could be performed with at least one turbine that allows the recovery of mechanical energy and cold duty. This energy can be provided to a generator or the turbine could be directly coupled to a booster.

The present invention proposes a configuration to start-up the carbon capture process and in particular for starting up the turbine which expands the gas from the at least one phase separator.

In a cryogenic carbon capture process on flue gas, the feed gas is compressed, dried, washed, subcooled, separated by at least one stage of partial condensation and liquid from the partial condensation is generally further purified in a distillation column. The cold duty for the condensation step is usually provided by the vaporization of the liquid CO2 that is not necessarily available during the start-up phase.

As a variant, a washing column may be present upstream of the partial condensation to remove the at least one component heavier than CO2.

There are several procedures potentially available for the start-up:
1. Liquid assist: liquid CO2 available in a storage tank is directly injected in the cold part of the process, either in the distillation column or in a separation vessel collecting liquid CO2 to be vaporized in the main heat exchanger. The vaporization of the liquid CO2 provides the required cold duty for the cooling of the equipment and for the cooling and the partial condensation of the flue gas. Providing that enough liquid is available, this is the fastest way to cool down the equipment and the flue gas being treated.
2. Refrigeration cycle: when the required cold duty for the flue gas condensation is provided by an external cycle, it can be used to cool down the equipment and the flue gas being treated. The cycle loop has first to be fed with the refrigerant that is employed (CO2 or an external refrigerant) and then the cycle is started (compression, condensation, expansion and vaporization).
3. Joule-Thomson valve: After the partial condensation separation vessel, the Joule-Thomson valve placed before the distillation column is used to generate a pressure drop inducing a temperature drop. The resulting cold stream is sent through the cold process and in particular to the main heat exchanger enabling the cooling of the equipment and of the flue gas treated. As soon as the flue gas is partially condensed, the obtained liquid is vaporized providing cold duty, allowing the flue gas to reach colder temperatures during consecutive cycles of expansion and vaporization.
4. Turbine: The turbine is used to expand the gas connected to the partial condensation vessel, generating cold temperatures at its outlet. This stream is sent back to the main heat exchanger enabling the cooling of the equipment and of the flue gas treated. This solution can be combined with the Joule-Thomson expansion solution.

### SUMMARY

A process for starting up a carbon capture process performed in an apparatus having a heat exchanger and at least one phase separator. The carbon capture process includes, under normal operation: a first stream of a gaseous mixture containing CO2 and at least one component lighter than CO2 is compressed, dried, cooled in the heat exchanger and separated by at least one partial condensation step in the at least one phase separator forming a liquid enriched in CO2 with respect to the mixture and a gas enriched in the at least one component lighter than CO2. And the gas enriched in the at least one component lighter than CO2 is warmed in the heat exchanger and then expanded in a turbine, emerging from the turbine and is sent to the atmosphere or to a cooling tower. Under start-up conditions, at least one phase separator is at a first temperature above 0° C. and a second stream of a gaseous mixture containing CO2 and at least one component lighter than CO2 is expanded in the turbine to produce an expanded gas at a second temperature different from the first temperature by at least 1° C. and lower than 0° C., the expanded gas being then warmed in the heat exchanger or sent to be separated in a distillation column of the carbon capture process.

A process for starting up a carbon capture process wherein in the carbon capture process under normal operation a gaseous mixture containing CO2, at least one component heavier than CO2 and at least one component lighter than CO2 is compressed, dried, cooled in a heat exchanger, separated in a washing column to form a feed stream containing proportionally less of the at least one component heavier than CO2 than the gaseous mixture, the feed stream containing proportionally less of the at least one component heavier than CO2 than the gaseous mixture being separated by a least one partial condensation step forming a liquid enriched in CO2 with respect to the feed stream and a gas enriched in the at least one component lighter than CO2 with respect to the feed stream. And the gas enriched in the at least one component lighter than CO2 is warmed in the heat exchanger and then expanded in a turbine, emerging from the turbine at a first temperature and is sent to the atmosphere or to a cooling tower. Wherein during start-up, a gas expanded in the turbine is produced at a second temperature differing from the first temperature by at least 1° C. but lower than 0° C., the expanded gas being then warmed in the heat exchanger or sent to the distillation column of the carbon capture process to cool down the distillation column.

### BRIEF DESCRIPTION OF THE FIGURES

For a further understanding of the nature and objects for the present invention, reference should be made to the following detailed description, taken in conjunction with the accompanying drawings, in which like elements are given the same or analogous reference numbers and wherein:

FIG. 1 is a schematic representation of a carbon capture process for separating a mixture containing CO2, at least one component heavier than CO2 and at least one component lighter than CO2, in accordance with one embodiment of the present invention.

FIG. 2 is a schematic representation of a carbon capture process for separating a mixture containing CO2 and at least one component lighter than CO2, in accordance with one embodiment of the present invention.

FIG. 3 is a schematic representation of a carbon capture process for a carbon capture process by partial condensation and stripping for separating a mixture containing CO2, at least one component heavier than CO2, and at least one component lighter than CO2, in accordance with one embodiment of the present invention.

FIG. 4 is a schematic representation of an intermediate phase following the initial phase of startup, in accordance with one embodiment of the present invention.

FIG. 5 is a schematic representation of a final phase of the startup, in accordance with one embodiment of the present invention.

### DESCRIPTION OF PREFERRED EMBODIMENTS

Illustrative embodiments of the invention are described below. While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

In some cases, a gaseous mixture to be separated, for example a flue gas, can contain impurities that can solidify at cold temperatures. Such impurities have to be removed before reaching the nominal lowest temperatures of the process. This step is normally performed by a washing column (this washing column being operated at a higher temperature than the partial condensation), contacting the dried compressed flue gas with liquid CO2, generating a lean gas and a liquid purge. But the liquid 10 required for this washing is not necessarily available during the start-up (since no liquid assist is available).

In other cases, if the gaseous mixture, in particular a flue gas, is separated in a process where refrigeration is provided by a turbine, if the turbine is coupled with a booster which provides pressure to the gaseous mixture, for example treated flue gas (in combination with a flue gas compressor) before its partial condensation, the booster has to be started as soon as possible. Otherwise, the partial condensation will not occur, or it will occur at a too low a pressure and thus at too low a temperature leading to the freezing of the impurities. In other words, without the booster, the impurities would freeze before being able to generate liquid in the partial condensation 20 and thus the reflux to the washing column. So, starting with a Joule Thomson valve alone is not possible.

Starting with the turbine is thus required. But the temperature at the discharge of the turbine in nominal conditions can be close to the lowest temperature of the process (−54.5° C.). If it is the case at the beginning of the start-up, the cooling effect by the expansion through the turbine could induce the generation of solids since the gas has not yet been washed. This would most probably damage the turbine and clog the equipment downstream.

The present invention in one variant proposes to throttle the discharge pressure of the turbine to limit its outlet temperature during start-up, in order to avoid the solidification of impurities. Thus, it is still possible to provide the power to boost the flue gas and perform the partial condensation at high pressure while providing enough cold duty to generate reflux to start-up the washing column. This variant applies in particular to the case where the mixture to be separated contains at least 40% CO2 and preferably less than 95% on a dry basis and at least one impurity chosen from the group oxygen, nitrogen, argon.

According to one object of the invention, there is provided a process for starting up a carbon capture process performed in an apparatus comprising a heat exchanger and at least one phase separator wherein in the carbon capture process
a) under normal operation:
i) A first stream of a gaseous mixture containing CO2 and at least one component lighter than CO2 is compressed, dried, cooled in the heat exchanger and separated by at least one partial condensation step in the at least one phase separator forming a liquid enriched in CO2 with respect to the mixture and a gas enriched in the at least one component lighter than CO2
ii) The gas enriched in the at least one component lighter than CO2 is warmed in the heat exchanger and then expanded in a turbine, emerging from the turbine and is sent to the atmosphere or to a cooling tower and
b) Wherein during start-up, at least one phase separator is at a first temperature above 0° C. and a second stream of a gaseous mixture containing CO2 and at least one component lighter than CO2 is expanded in the turbine to produce an expanded gas at a second temperature different from the first temperature by at least 1° C. and lower than 0° C., the expanded gas being then warmed in the heat exchanger or sent to be separated in a distillation column of the carbon capture process.

According to other optional features:
the expanded gas sent to the turbine is warmed by a heater downstream of the heat exchanger during normal operation and optionally is not warmed by the heater during start-up.
the gas sent to the turbine is not throttled downstream of the turbine during normal operation and is throttled downstream of the turbine in order to discharge at a warmer temperature during start-up.
during normal operation, the liquid enriched in CO2 with respect to the mixture is separated in a washing column and during start-up at least part of the expanded gas is liquefied by the expansion step and sent to the washing column.
during start-up at least part of the expanded gas is liquefied by the expansion step and sent to the heat exchanger to be vaporized therein.
during start-up, the gas expanded in the turbine is the gaseous mixture which has been sent via the heat exchanger to the phase separator, from the phase separator to the heat exchanger and then to the turbine.
during start-up, the gas expanded in the turbine is at least part of the gaseous mixture which is sent to the turbine directly after being dried.
during start-up, between 15 and 40% of the gaseous mixture is sent to the turbine directly after being dried and between 60 and 85% of the gaseous mixture is sent to the heat exchanger and then to the phase separator.
during start-up during a first phase the gas expanded in the turbine is at least part of the gaseous mixture which is sent to the turbine directly after being dried and during a second phase following the first phase, the gas expanded in the turbine is the gaseous mixture which has been sent via the heat exchanger to the phase separator, from the phase separator to the heat exchanger and then to the turbine.
the outlet temperature of the turbine during start-up is between −20° C. and −50° C., preferably between −20° C. and −30° C.

According to another object of the invention, there is provided a process for starting up a carbon capture process wherein in the carbon capture process under normal operation:
i) A gaseous mixture containing CO2, at least one component heavier than CO2 and at least one component lighter than CO2 is compressed, dried, cooled in a heat exchanger, separated in a washing column to form a feed stream containing proportionally less of the at least one component heavier than CO2 than the gaseous mixture, the feed stream containing proportionally less of the at least one component heavier than CO2 than the gaseous mixture being separated by a least one partial condensation step forming a liquid enriched in CO2 with respect to the feed stream and a gas enriched in the at least one component lighter than CO2 with respect to the feed stream
ii) The gas enriched in the at least one component lighter than CO2 is warmed in the heat exchanger and then expanded in a turbine, emerging from the turbine at a first temperature and is sent to the atmosphere or to a cooling tower
Wherein during start-up, a gas expanded in the turbine is produced at a second temperature differing from the first temperature by at least 1° C. but lower than 0° C., the expanded gas being then warmed in the heat exchanger or sent to the distillation column of the carbon capture process to cool down the distillation column.

According to other optional features:
the gas sent to the turbine is warmed by a heater downstream of the heat exchanger during normal operation and optionally is not warmed by the heater during start-up.
the gas sent to the turbine is not throttled downstream of the turbine during normal operation and is throttled downstream of the turbine in order to discharge at a warmer temperature during start-up.
during normal operation, the liquid enriched in CO2 with respect to the feed stream is separated in a stripping column and during start-up at least part of the expanded gas is liquefied by the expansion step and sent to the stripping column.
during start-up at least part of the expanded gas is liquefied by the expansion step and sent to the heat exchanger to be vaporized therein.
during start-up, the gas expanded in the turbine is the gaseous mixture which has been sent via the heat exchanger to the phase separator, from the phase separator to the heat exchanger and then to the turbine.
during start-up, the gas expanded in the turbine is the gaseous mixture which is sent to the turbine directly after being dried.
in normal operation, the feed stream is compressed in a compressor between the stripping column and the phase separation.
the compressor is coupled to the turbine.
during start-up, between 15 and 40% of the gaseous mixture is sent to the turbine directly after being dried and between 60 and 85% of the gaseous mixture is sent to the heat exchanger and then to the phase separator.
during start-up during a first phase the gas expanded in the turbine is at least part of the gaseous mixture which is sent to the turbine directly after being dried and during a second phase following the first phase, the gas expanded in the turbine is the gaseous mixture which has been sent via the heat exchanger to the phase separator, from the phase separator to the heat exchanger and then to the turbine.
the outlet temperature of the turbine during start-up is between −20° C. and −50° C., preferably between −20° C. and −30° C.
during the start-up, liquid formed in the phase separator is sent to the top of the washing column.

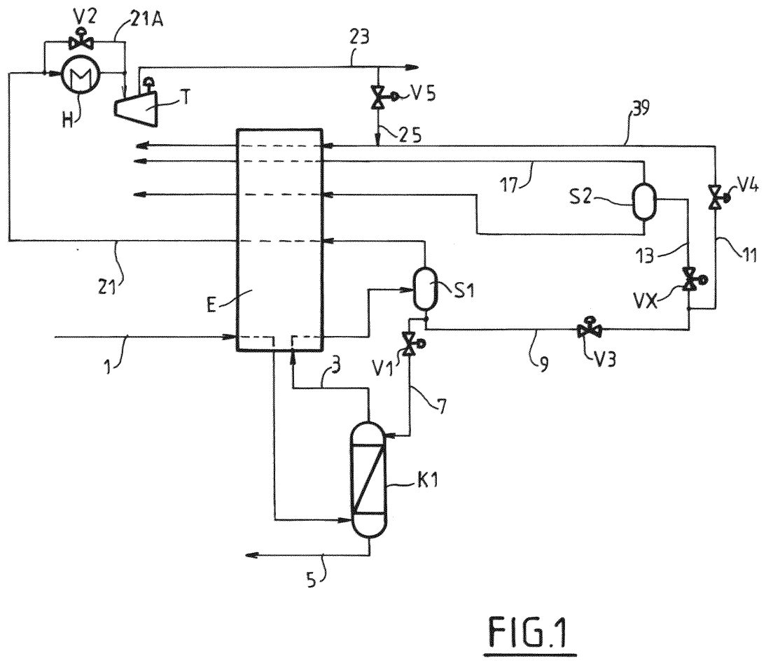

The invention will be described in more detail, by referring to the figures, where FIGS. 1 to 5 represent carbon capture processes capable of being started up by the process according to the invention.

FIG. 1 shows a carbon capture process for separating a mixture 1 containing CO2, at least one component heavier than CO2, such as NOx and at least one component lighter than CO2, such as nitrogen, oxygen, carbon monoxide. The apparatus comprises a washing column K1 and two-phase separators S1, S2.

Under normal operation, in other words, when operating as the process is intended to operate to capture CO2, a first stream of gaseous mixture 1 containing CO2, at least one component heavier than CO2 and at least one component lighter than CO2 is compressed, dried, cooled in a heat exchanger E to an intermediate temperature thereof and separated to form a liquid enriched in the heavier component 5 and a gas 3 depleted in the at least one heavier component and enriched in the at least one lighter component and in CO2 in column K1 fed at the top by a wash stream 7. The gas 3 is then partially condensed in exchanger E and separated in phase separator S1. Liquid 7 from the phase separator S1 via open valve V1 is sent as wash liquid to the top of column K1 and liquid 9 from the phase separator S1 can be used at least in part as a liquid product and/or vaporized in heat exchanger E to form a vaporized product. In this particular figure, the stream 9 is expanded in valve V3 and is split in two, one part 11 being expanded in valve V4 to form stream 39 and the other part 13 being expanded in valve VX to form a two-phase mixture, which is separated in separator S2. The gas 17 from separator S2 is warmed in the heat exchanger E and the liquid from the separator S2 and liquid 39 are vaporized in heat exchanger E. At least one of these streams may form the product of the process.

Under normal operation, the gas 21 from separator S1 is a gas enriched in the at least one component lighter than CO2 compared with stream 1. It is warmed in the heat exchanger E to the warm end thereof and then warmed by heater H, valve V2 being closed. Gas 21 is then expanded in a turbine T, emerging from the turbine at a temperature below 0° C., preferably below −35° C., and is sent to the atmosphere or to a cooling tower as gas 23 or used as a regeneration gas for a drier used to dry gas 1. It may be at a pressure between 1,2 and 10 bars abs.

During start-up, when at least one of phase separators S1, S2 is at a first temperature above their normal operating temperature, for example above 0° C. or even above 10° C., a second stream of a gaseous mixture 1 containing CO2, at least one component heavier than CO2 and at least one component lighter than CO2 is sent to the apparatus of FIG. 1. This stream may have the same composition or a different composition to the gas used in the normal operation. According to the figure, the gas 1 enters column K1 without any separation taking place and then flows into the phase separator S1. The gas 1 is sent through heat exchanger E initially without being warmed and is not warmed in heater H, passing via valve V2 as stream 21A or by simply not switching on heater H. It is thus essentially the gas 1 which is expanded in the turbine T forming gas 23. By virtue of the turbine expansion, the gas 23 is produced at a second temperature lower than the first temperature and lower than 0° C., at least part 25 of the expanded gas 23 being then sent via valve V5 to be warmed in the heat exchanger or to be separated in a distillation column of the carbon capture process (not shown in this figure). Thus stream 23, 25 contributes to the cooling down of the apparatus and speeds up the startup process.

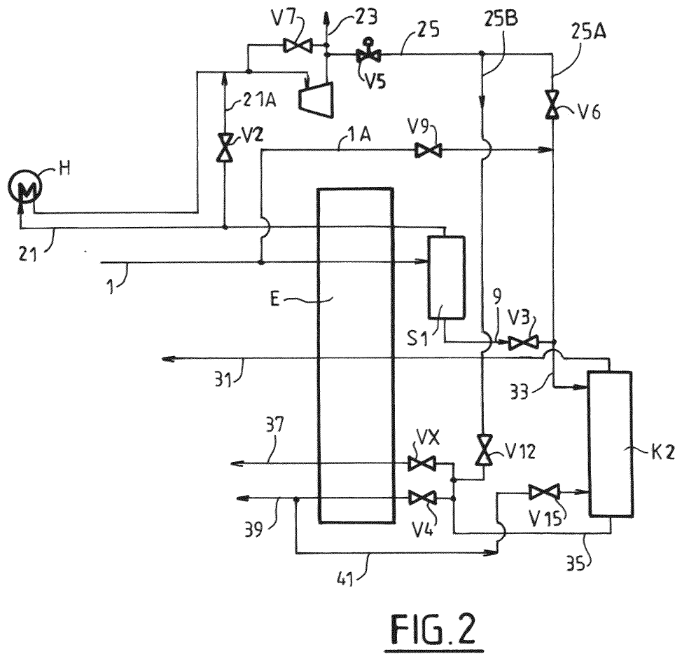

FIG. 2 shows a carbon capture process for separating a mixture 1 containing CO2 and at least one component lighter than CO2, such as nitrogen, oxygen, carbon monoxide. The apparatus comprises a stripping column K2 and a phase separators S1.

Under normal operation, in other words, when operating as the process is intended to operate to capture CO2, a first stream of gaseous mixture 1 containing CO2, and at least one component lighter than CO2 is compressed, dried, cooled in a heat exchanger E to the cold end thereof, partially condensed. It is separated by a least one partial condensation step forming a liquid 9 enriched in CO2 with respect to the mixture 1 and a gas 21 enriched in the at least one component lighter than CO2. In this particular figure, liquid 9 from the phase separator S1 is sent via valve V3 to the top of stripping column K2 to be separated, forming a gas enriched in the at least one lighter component and depleted in CO2 31 and a liquid 35. Liquid 35 is split in two, one part being expanded in valve V4 to form stream 39 and the other part being expanded in valve VX to form stream 37. The liquids are vaporized in heat exchanger E. At least one of these streams may form the product of the process. Part of stream 39 is taken, after the warming step to form a reboil gas sent via valve V15 to the bottom of column K2.

The gas 21 from separator S1 is a gas enriched in the at least one component lighter than CO2 as compared with stream 1. It is warmed in the heat exchanger E to the warm end thereof and then warmed by heater H, valve V6 being closed. Gas 21 is then expanded in a turbine T, emerging from the turbine at a temperature below 0° C. preferably below −35° C. and is sent to the atmosphere or to a cooling tower as gas 23 or used as a regeneration gas.

During start-up, when phase separators S1 and column K2 are at a first temperature above their normal operating temperature, for example above 0° C. or even above 10° C., a second stream of a gaseous mixture 1 containing CO2, at least one component heavier than CO2 and at least one component lighter than CO2. This stream may have the same composition or a different composition to the gas used in the normal operation. According to the figure, the gas 1 enters heat exchanger E without being cooled initially and then flows into the phase separator S1. The gas from the top of the phase separator S1 has the composition of gas 1 and is sent through heat exchanger E initially without being warmed and is not warmed or not fully warmed in heater H, passing fully or partially via valve V6 as stream 21A or by simply not fully switching on heater H. It is thus a gas having the composition of the second stream gas 1 which is expanded in the turbine T forming gas 23. By virtue of the turbine expansion, the gas 23 is produced at a second temperature lower than the first temperature and lower than 0° C., at least part 25B of the expanded gas 25 being then expanded in valve V12 to form a gas, which is warmed in the heat exchanger, preferably after mixing with gaseous stream 35. Alternatively, or additionally at least part of stream 25 is sent as stream 25A to be expanded in valve V6 forming a gas, which feeds column K2 in the absence of stream 9 or later in startup with a reduced flow of stream 9. In this way, column K2 is cooled down more rapidly and the column can begin to function earlier. Stream 25A goes out of the cold part through the stream 31. Thus stream 25 contributes to the cooling down of the apparatus and speeds up the startup process. First liquid level will appear in the separator S1. When, this level is obtained, valve V6 is closed and valve V1 opens. Then, when there is some liquid level at the bottom of K2, valve V12 can be closed.

Instead of being heated in heater H, the gas 21 may be sent via a bypass 21A and valve V2 to the turbine T. Otherwise the heater H may simply be switched off.

In this procedure, the entry temperature of turbine T is higher during normal operation than during startup. The composition of the expanded stream in turbine T is preferably richer in the at least one lighter component and contains proportionally less CO2 during normal operation than during startup.

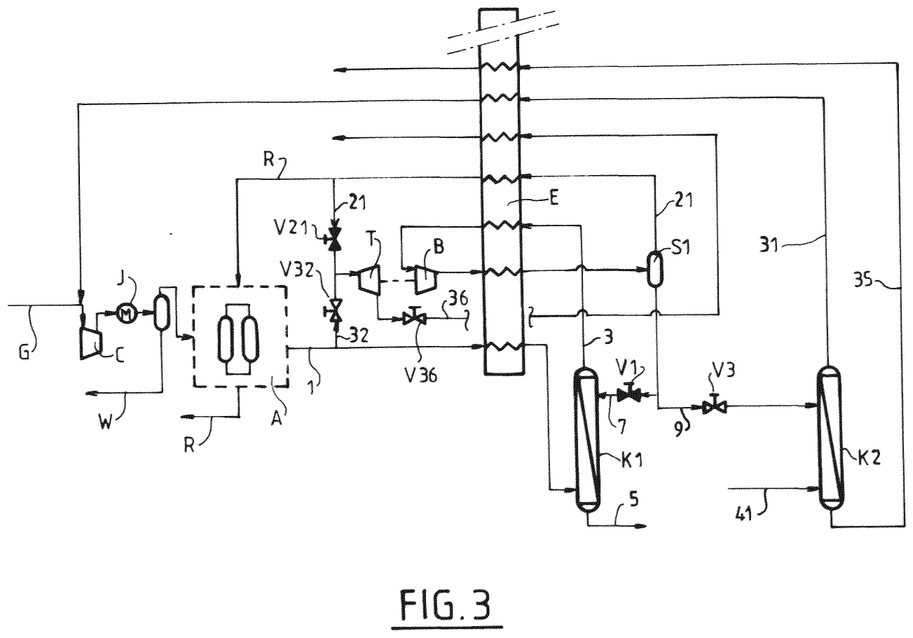

FIG. 3 shows a carbon capture process by partial condensation and stripping (considered to be a form of distillation) for separating a mixture 1 containing CO2, at least one component heavier than CO2, such as NOx and at least one component lighter than CO2, such as nitrogen, oxygen, carbon monoxide. The apparatus comprises a washing column K1 and two-phase separator S1.

Under normal operation, in other words, when operating as the process is intended to operate to capture CO2, a gas G containing CO2, at least one component heavier than CO2 and at least one component lighter than CO2 is compressed, by compressor C, cooled in cooled J, dried first by removal of condensed water W and then by adsorption A, forming a compressed dry stream which is a first stream of gaseous mixture 1 containing CO2, at least one component heavier than CO2 and at least one component lighter than CO2. Gas 1 is cooled in heat exchanger E and separated in washing column K1 to form a liquid enriched in the heavier component 5 and a gas 3 depleted in the at least one heavier component and enriched in the at least one lighter component and in CO2. Column K1 is fed at the top by a wash stream 7, valve V1 being open. The gas 3 is warmed in heat exchanger E, compressed in compressor B, cooled and partially condensed in exchanger E and separated in phase separator S1.

Liquid from separator S1 is divided in two, part 7 forming the wash stream for column K1 and part 9 being sent as feed to stripping column K2. Stripping column K2 separates stream 9 sent via valve V3 to remove the at least one lighter component, forming a gas 31 enriched in the at least one lighter component and a liquid depleted in the at least one lighter component which can be the product in liquid form and/or gaseous form, following vaporization in the heat exchanger E. Stream 41 provides reboil to the column K2.

Gas 21 from the phase separator S1 is warmed in the heat exchanger E and is divided in two, one part R being used as regeneration gas for the adsorption unit A and the rest 21 being expanded in the turbine T via open valve V21 from between 40 bara to 16 bara to between 10 bara to 1.5 bara, valve V32 being closed. The expanded stream from the turbine is at between −30° C. and −54.5° C. and it is then throttled in valve V36 to limit the discharge temperature from the turbine to between −20° C. and −30° C. (the pressure can be for example between 2 and 4 bara at turbine discharge). The expanded stream is not cooled in the heat exchanger E but is warmed from the cold end thereof to the warm end. The expanded gas may be sent to the atmosphere, used to regenerate the drier or sent upstream of the process.

Alternatively, all the gas 21 can be directed to the turbine T, in which case steam 36 downstream of heat exchanger E can be used for regeneration of the drier A
1. During start-up, during an initial phase, when phase separators S1 and columns K1 and K2 are at a first temperature above their normal operating temperature, for example above 0° C. or even above 10° C., a second stream of a gaseous mixture 1 containing CO2, at least one component heavier than CO2 and at least one component lighter than CO2 is sent to the apparatus. This stream may have the same composition or a different composition to the gas used in the normal operation. According to the FIG. 3, the beginning of the startup process is illustrated by the shading of valves V1, V3, V21, V32, valves V21 and V1 being closed (shown in black) and valves V3 and V32 being open (shown in white). The gas 1 is divided into two streams, one of which 32 is sent via open valve 32 to be expanded in turbine T, preferably following expansion in valve V32. This new by-pass 32 is thus used to send a part of the dry gas 1 directly to the turbine T and the other part is sent to the cold process. Preferably 15 to 40% of the flowrate of gas 1 is sent to the turbine T without passing via heat exchanger E or column K1 and 60-85% to the cold process via heat exchanger E and column K1. The valve V32 is necessary to decouple the flow between the expander and the booster. Without this valve, the two flow rates would be the same, or at least the flowrate of the turbine would need to be below the flowrate of the booster.
2. The gas 1 enters column K1 without any separation taking place since valve V1 is closed and then is compressed by booster compressor B and flows into the phase separator S1. The compressor B is able to function since stream 32 is being expanded in turbine T which is coupled to booster B. The power provided by the turbine drives the booster allowing to perform the partial condensation at a higher pressure

The gas from S1 is not expanded in the turbine T since valve V21 is closed. Thus, all the gas from S1 is used at the regeneration gas for adsorption unit 1.

The turbine inlet flow is adjusted to operate as close as possible to its nominal power output considering that it operates at its nominal pressure and temperature but with an inlet composition that differs from its normal operation since it has not been separated in, or even sent to, separator S1.

The cold produced by the turbine T by expanding from between 16 and 40 bara to between 11 and 13 bara or between 2 and 4 bara produces a stream at −30° C. Additional cold could be produced in the cold process through the Joule-Thomson expansion of the dry process gas in valve V32 enabling the cooling down of column K2 and later the start of the condensation process.

The discharge pressure of the turbine T is reduced by throttling by using a valve V36 to limit the discharge temperature between −20° C. and −30° C. (the pressure can be for example between 2 and 4 bara at turbine T discharge). The gas 36 at the turbine discharge is warmed in heat exchanger E from the cold end thereof. This temperature range allows the process to produce liquid reflux 7 that is sent to the washing column K1 as soon as it is available, while avoiding impurities solidification.

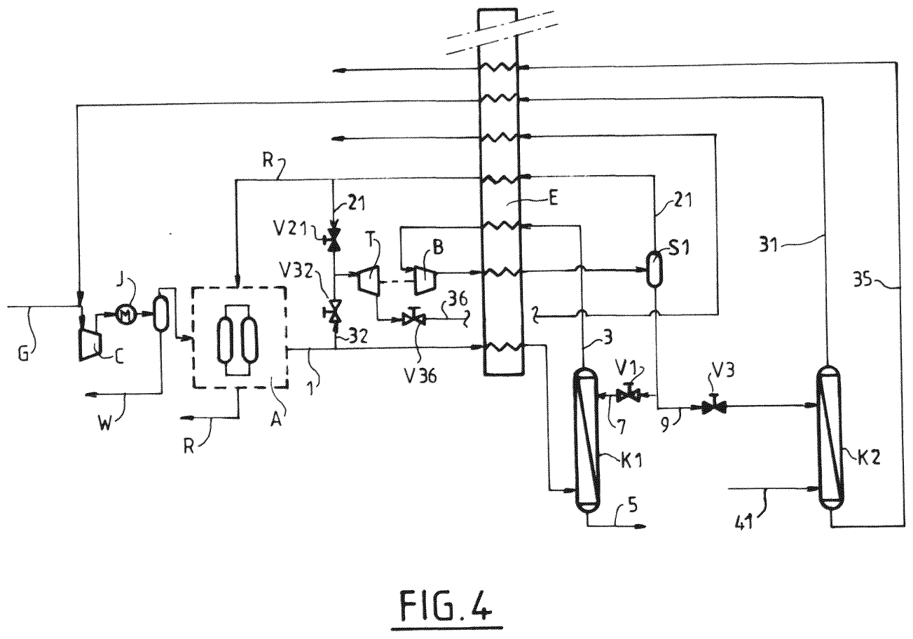

Thus, in an intermediate phase (FIG. 4), following the initial phase of startup, the washing column K1 is started using the liquid CO2 7 produced by the partial condensation in separator S1 sent via valve V1, shown in FIG. 4 as being open. By closing the Joule-Thomson valve V3, it is possible to avoid temperatures which are too low and the risk of impurities freezing.

No liquid is sent to column K2, valve V3 being closed.

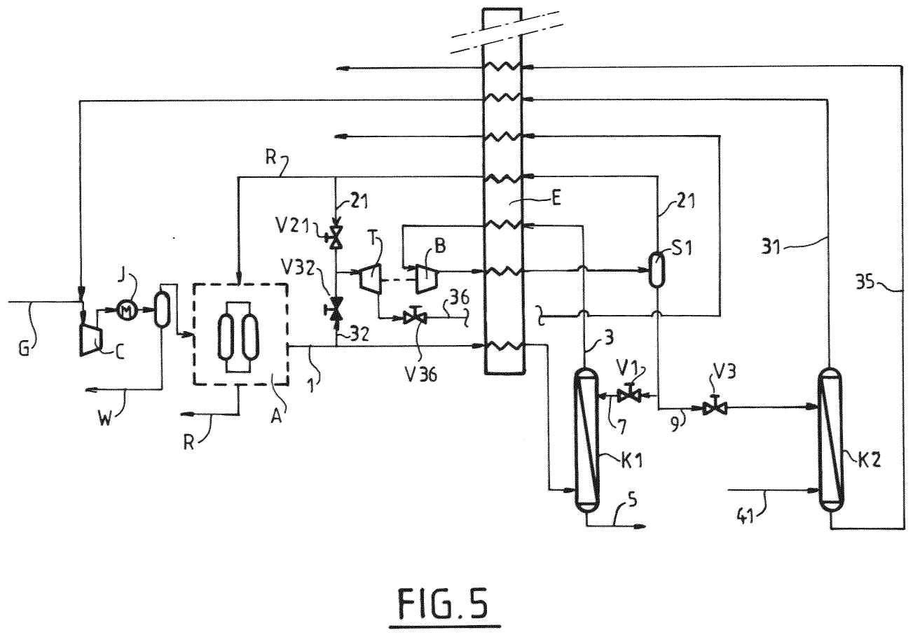

In a final phase of the startup as shown in FIG. 5, the operation mode of the turbine T is changed to receive no more gas 1 directly without passing through the heat exchanger E. The gas is sent from the phase separator S1 as stream 21, valve V21 being open and valve V32 closed. Valve V36 is then fully open not prevent throttling at the turbine discharge and then the start-up is finalized (further cooling down, other purification steps start-up etc., both columns K1, K2 are in operation).

In FIGS. 3 to 5, a heater (not shown) may be used to warm gas sent to turbine T both during normal operation and during start-up.

FIGS. 1 to 2 are particularly useful for separation of a mixture containing at least 15% mol and preferably less than 50% mol CO2 on a dry basis. The mixture may also contain at least one impurity chosen from the group oxygen, nitrogen and argon. This could typically be the case for a flue gas separation.

FIGS. 3 to 5 are particularly useful for separation of a mixture containing at least 40% mol and preferably less than 95% mol CO2 on a dry basis. The mixture may also contain at least one impurity chosen from the group oxygen, nitrogen and argon. This could typically be the case for a gaseous mixture produced by oxyfuel combustion.

It will be appreciated that the ranges given here overlap and other considerations may determine the choice of the optimal figure.

In normal operation, for FIGS. 3 to 5, the gas expanded through the turbine may be routed back to a PSA, thus the discharge pressure of the turbine is around 9 bar (leading to a temperature around −36° C.) while for FIGS. 1 and 2, the gas that is expanded is later vented (close to atmospheric pressure). The pressure ratio through the turbine in FIGS. 1 and 2 is greater than in FIGS. 3 to 5 so even though the stream 21 is warmed before expanding it, the discharge temperature from the turbine is close to −54.5° C.

This means that during start-up the turbine outlet for FIGS. 3 to 5 needs to be colder than during normal operation, whereas the turbine outlet for FIGS. 1 to 2 needs to be warmer.

However otherwise the start-up principle is the same:
1) The turbine discharges at a temperature between −20° C. and −30° C. that allows enough liquid reflux to be generated to start the washing column without freezing impurities.
2) Once the flue gas is clean, the turbine discharges at a lower temperature (as close to −54.5° C. as possible) that enables the quick cool down of the cold section.

1. A process for starting up a carbon capture process performed in an apparatus comprising a heat exchanger and at least one phase separator wherein in the carbon capture process:
a) under normal operation:
i) a first stream of a gaseous mixture containing CO2 and at least one component lighter than CO2 is compressed, dried, cooled in the heat exchanger and separated by at least one partial condensation step in the at least one phase separator forming a liquid enriched in CO2 with respect to the mixture and a gas enriched in the at least one component lighter than CO2; and
ii) the gas enriched in the at least one component lighter than CO2 is warmed in the heat exchanger and then expanded in a turbine, emerging from the turbine and is sent to the atmosphere or to a cooling tower;
b) under start-up conditions
a) at least one phase separator is at a first temperature above 0° C. and a second stream of a gaseous mixture containing CO2 and at least one component lighter than CO2 is expanded in the turbine to produce an expanded gas at a second temperature different from the first temperature by at least 1° C. and lower than 0° C., the expanded gas being then warmed in the heat exchanger or sent to be separated in a distillation column of the carbon capture process.

2. The process according to claim 1 wherein the expanded gas sent to the turbine is warmed by a heater downstream of the heat exchanger during normal operation and optionally is not warmed by the heater during start-up.

3. The process according to claim 1 wherein the gas sent to the turbine is not throttled downstream of the turbine during normal operation and is throttled downstream of the turbine in order to discharge at a warmer temperature during start-up.

4. The process according to claim 1 wherein during normal operation, the liquid enriched in CO2 with respect to the mixture is separated in a washing column and during start-up at least part of the expanded gas is liquefied by the expansion step and sent to the washing column.

5. The process according to claim 1 wherein during start-up at least part of the expanded gas is liquefied by the expansion step and sent to the heat exchanger to be vaporized therein.

6. The process according to claim 1 wherein during start-up, the gas expanded in the turbine is the gaseous mixture which has been sent via the heat exchanger to the phase separator, from the phase separator to the heat exchanger and then to the turbine.

7. The process according to claim 1 wherein during start-up, the gas expanded in the turbine is at least part of the gaseous mixture which is sent to the turbine directly after being dried.

8. The process according to claim 7 wherein during start-up, between 15 and 40% of the gaseous mixture is sent to the turbine directly after being dried and between 60 and 85% of the gaseous mixture is sent to the heat exchanger and then to the phase separator.

9. The process according to claim 7 wherein during start-up during a first phase the gas expanded in the turbine is at least part of the gaseous mixture which is sent to the turbine directly after being dried and during a second phase following the first phase, the gas expanded in the turbine is the gaseous mixture which has been sent via the heat exchanger to the phase separator, from the phase separator to the heat exchanger and then to the turbine.

10. The process according to claim 1 wherein the outlet temperature of the turbine during start-up is between −20° C. and −50° C.

11. A process for starting up a carbon capture process wherein in the carbon capture process under normal operation:
i) a gaseous mixture containing CO2, at least one component heavier than CO2 and at least one component lighter than CO2 is compressed, dried, cooled in a heat exchanger, separated in a washing column to form a feed stream containing proportionally less of the at least one component heavier than CO2 than the gaseous mixture, the feed stream containing proportionally less of the at least one component heavier than CO2 than the gaseous mixture being separated by at least one partial condensation step forming a liquid enriched in CO2 with respect to the feed stream and a gas enriched in the at least one component lighter than CO2 with respect to the feed stream;
ii) the gas enriched in the at least one component lighter than CO2 is warmed in the heat exchanger and then expanded in a turbine, emerging from the turbine at a first temperature and is sent to the atmosphere or to a cooling tower;
wherein during start-up, a gas expanded in the turbine is produced at a second temperature, wherein a temperature difference between the first temperature and the second temperature is to be at least 1° C. and the temperature of the second temperature is lower than 0° C., the expanded gas being then warmed in the heat exchanger or sent to the distillation column of the carbon capture process to cool down a distillation column.

12. The process according to claim 11 wherein the gas sent to the turbine is warmed by a heater downstream of the heat exchanger during normal operation and optionally is not warmed by the heater during start-up.

13. The process according to claim 11 wherein the gas sent to the turbine is not throttled downstream of the turbine during normal operation and is throttled downstream of the turbine in order to discharge at a warmer temperature during start-up.

14. The process according to claim 11 wherein during normal operation, the liquid enriched in CO2 with respect to the feed stream is separated in a stripping column and during start-up at least part of the expanded gas is liquefied by the expansion step and sent to the stripping column.

15. The process according to claim 11 wherein during the start-up at least part of the expanded gas is liquefied by the expansion step and sent to the heat exchanger to be vaporized therein.

16. The process according to claim 11 wherein during start-up, the gas expanded in the turbine is the gaseous mixture which has been sent via the heat exchanger to the phase separator, from the phase separator to the heat exchanger and then to the turbine.

17. The process according to claim 11 wherein during the start-up, the gas expanded in the turbine is the gaseous mixture which is sent to the turbine directly after being dried.

18. The process according to claim 11 wherein in the normal operation, the feed stream is compressed in a compressor between a stripping column and a phase separation.

19. The process according to claim 18 wherein the compressor is coupled to the turbine.

20. The process according to claim 17 wherein during the start-up, between 15 and 40% of the gaseous mixture is sent to the turbine directly after being dried and between 60 and 85% of the gaseous mixture is sent to the heat exchanger and then to a phase separator.
